(19) United States
(12) Patent Application Publication
(10) Pub. No.: US 2003/0140254 A1
(43) Pub. Date: Jul. 24, 2003

(54) Method for assuring security by remote means when downloading active data

(76) Inventor: Nicolas Bouthors, Meylan (FR)

Correspondence Address: David D. Stein, Boyle, Fredrickson, Newholm, Stein & Gratz, S.C., Suite 1030, 250 E. Wisconsin Avenue, Milwaukee, WI, 53202, US

(21) Appl. No.: 10/335,407

(22) Filed: Dec. 31, 2002

(30) Foreign Application Priority Data
Dec. 31, 2001 (FR) FR 01 17097

(51) Int. Cl. H04L 9/00

(52) U.S. Cl. 713/201

(57) ABSTRACT

In order to relieve the work load on a terminal, and assure its secure use, the functions necessary for verifying the content of messages addressed to a subscriber using the terminal are shifted to the operator. When it receives (202) a message from a provider, the operator assumes responsibility of verifying (203-204) the message content, the origin of the message, and of ensuring that the subscriber indeed wishes to receive this type of message from this provider. These actions are performed without soliciting the subscriber. Thus when active content is received (211) by the terminal this content is executed (212) without any other verification because the verification has already been performed by the operator.

The present invention relates to a method for remotely assuring security when downloading active data in a terminal. The field of the invention is networks in which it is possible to access such data, such access being contingent on a subscription agreement with an access provider. Networks of such kind may be, for example, the Internet for private individuals, or mobile telephony networks. In order to gain access to data and to these networks, the user of a terminal that allows connection to these networks is effectively obliged to take out a subscription. One aim of the invention is to reinforce the confidence of users in networks of such kind. A further aim of the invention is to minimise the impact of security procedures on the end user.

Systems are known in the state of the art that enable content or data, described as active, to be received by a device such as a personal computer. Content is considered to be active when its interpretation engages functions other than the function of display on the device by which it is interpreted. Besides its display function, the functions of a device may include for instance communication, storage, and processing.

According to the state of the art and in the field of personal computers there are at least two major types of active content: active content that is accepted by default, which includes scripts, Java type “applets”, and active content which cannot be downloaded or initialised without the active authorisation of the device user. The latter types of active content are known as “plug-ins” or extensions to the browser software. When such an extension is downloaded, the user receives a request to accept the extension. To make his choice easier, the extension is accompanied by a certificate that enables him to identify the organisation or service provider which is transmitting the extension. An extension of such kind enables improved control of browser software, for example, on the device that is used to run the software.

The two types of active content indicated in the aforegoing are received by a user's device following a request made by the user. In other words, a user has transmitted a request, using the HTTP (Hypertext Transfer Protocol) protocol for example, to receive a Web page, which is a file in HTML (Hypertext Markup Language) format. This file in HTML format then includes the active content which is interpreted by the browser software.

A first problem in this arrangement is that the user is not naturally disposed to handling the certificates-that accompany the extensions. Thus, the browser software displays a prompt requesting the user to confirm that he accepts the extension, which has been transmitted by such and such an organisation. As often as not, the user does not understand the “jargon” that accompanies this question and does not attempt to verify the validity of the certificate. It is then possible for ill-intentioned persons to pass themselves off as a reputable organisation, or simply disguise their nefarious purposes. This being the case, the user who is aware of such may prefer to refuse the extensions in most cases rather than expose himself to the smallest risk. In doing so, in his attempt to exercise caution, the user limits the services to which he might have access if a system existed that would allow him to place greater confidence in the methods used to disseminate such extensions.

This problem also exists in the domain of mobile telephony. It should be noted that it is indeed possible to access the Internet, i.e. active content as described above, from a mobile telephone. However, the problem in the case of mobile telephony is further aggravated by the existence of “push” mode. This means that the user of a mobile telephone end device may receive active content without having authorised the receipt. This mode of functioning owes its existence to the fact that mobile end devices need to conserve energy. It is expensive for a mobile end device to have to interrogate servers regularly within the context of a messaging application, for example. It is much simpler for the messaging server to send a message to the mobile end device as and when a message is addressed thereto.

Moreover, the control functions that are exercised in a unit of the mobile end device type by scripts or “applets” that are compatible with that mobile end device are significantly more extensive than is the case for personal computers. It is therefore advisable to exercise extreme caution when handling such active content in a mobile end device. The prudent user declines them almost as a matter of course.

A further problem associated with mobile end devices consists in that their storage capacity is low, and their computing capacity is limited. This means that they are unable not only to store certificates in a database, but also to process such a certificate database in real time. Consequently, a solution modelled on the one that is used in the field of personal computers cannot be implemented for mobile telephony. Moreover, if such a solution were to be implemented, it would not be ergonomically acceptable because it would require the user to make an active response, as in the field of personal, computers. Such is therefore not ideal.

According to the invention, these problems are solved by devolving the function of security verification to the network operator. Thus, according to the invention, a user who subscribes to the operator accesses active content, whether requested or not, according to his own wishes. All information to which the user wishes to have access is passed via the operator, that is to say via one of its servers. The operator is therefore able to analyse all data that passes through its servers in order to find active content. When the operator detects active content, it determines the identity of the sending party. If the sending party is known to and approved by the operator, the operator confirms whether the subscriber to whom the active content is addressed is willing to receive this type of active content. If the subscriber is willing to receive this type of active content, the operator transmits said active content to the subscriber. This security assurance is entirely transparent to the operator's subscriber. it allows the user to use his terminal without worrying about the security implications surrounding such use, since security is assured by the operator. At the same time, the user may configure his terminal to reflect the types of content he would like to have blocked by the operator. This configuration may be stored on the terminal and transmitted regularly to the server of the operator that is handling security, or may be stored directly on that operator's server. In the latter case, the user himself may access the server to change his configuration.

The object of the invention therefore is a method for remotely assuring security when downloading active data in a terminal by an operator, characterised in that the operator, which serves as the interface between the terminal and a provider who is sending the active data, implements the following steps:

receipt of a message, via a first telecommunications network,

determination of the nature of the received message, to learn whether the nature of the received message is such that this received message includes active data,

identification of the provider sending the active data,

verification of the provider's accreditation, depending on the nature of the message, based on a provider memory on a second network managed by the operator,

identification of the receiving terminal of the active data based on a subscriber memory,

verification of the receiving terminal's configuration,

if the configuration is compatible with the active data, and if the provider is approved, the operator relays the active data to the terminal.

The invention will be better understood with reference to the following description and to the attached drawings. The drawings are for representational purposes only and are not to be considered limiting of the invention in any way. In the drawing:

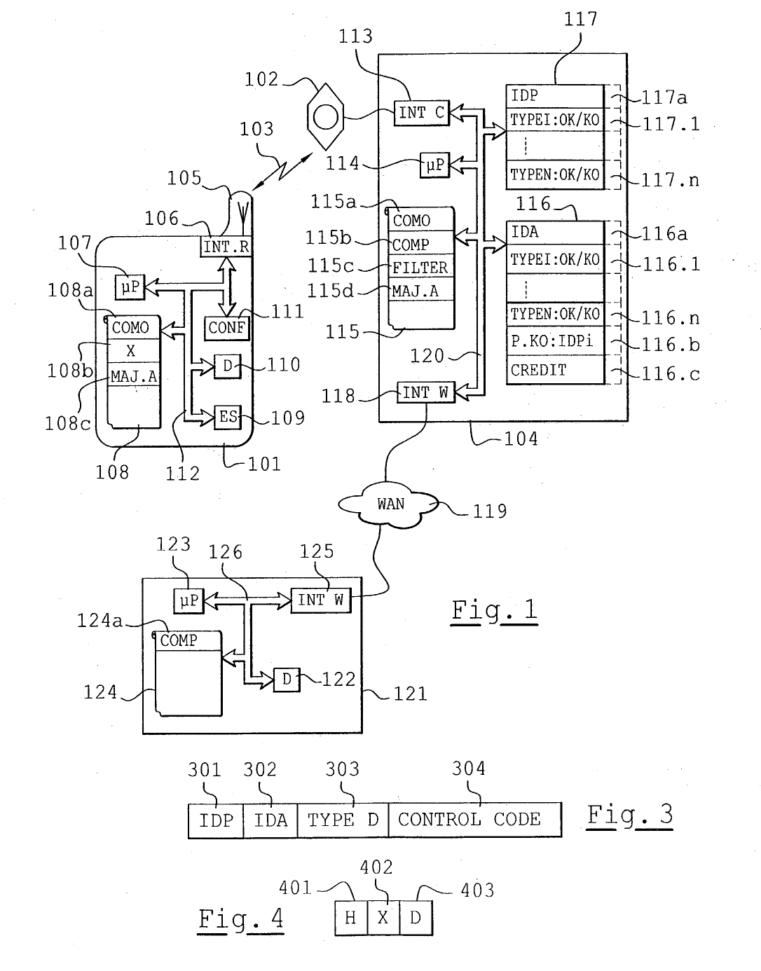

FIG. 1: is an illustration of means useful for realising the process according to the invention;

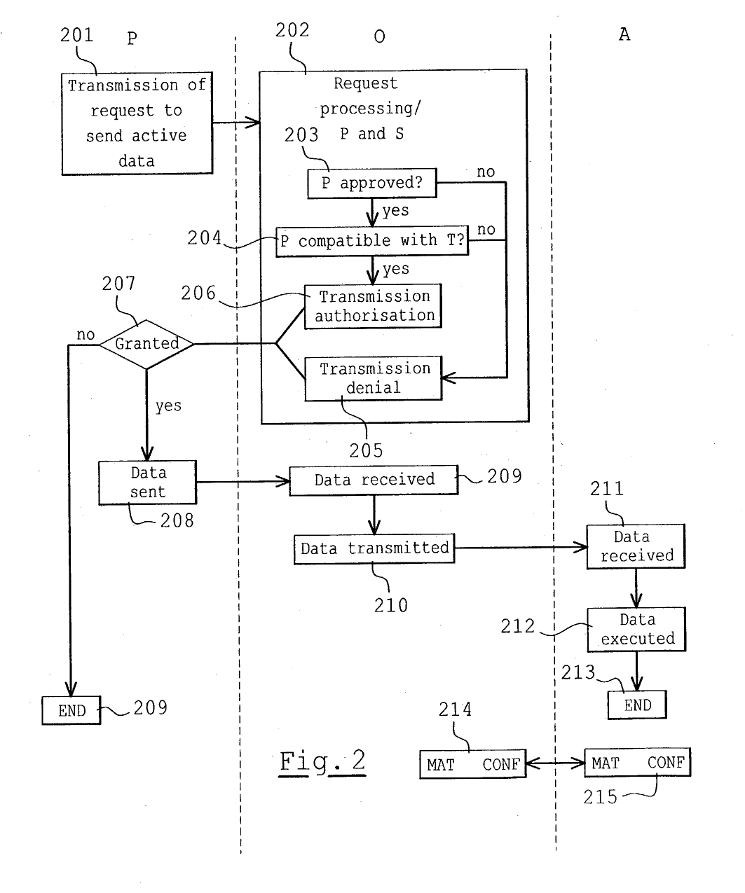

FIG. 2: is an illustration of process stages according to the invention;

FIG. 3: is an illustration of fields that are included in a frame allowing a provider to communicate with the operator;

FIG. 4: is an illustration of a frame allowing the operator to communicate with a terminal.

The following description relates to the operator, the subscriber, and the provider. All are present on one or more networks. The subscriber uses a mobile telephone end device to communicate with the equipment managed by the operator. The provider has a server that enables it to communicate with the operator's equipment. In the description, actions are attributed to the terminal, the subscriber, the operator, and the provider. Of course, these actions are performed by the equipment corresponding to these different entities. Accordingly, an action performed by the subscriber is realised via his terminal and the microprocessor included in that terminal. The microprocessor is controlled by instruction codes recorded in a terminal memory. The same applies to the servers managed by the operators and the providers. Every server includes a microprocessor and a program memory including instruction codes for controlling these microprocessors.

FIG. 1 shows a terminal 101 that is connected to a telecommunications network 102 via a microwave link 103. For the purpose of the description, and in a preferred embodiment, network 102 is considered to be a mobile telephone cellular network, and terminal 101 is therefore a mobile telephone. Network 102 is managed by a mobile telephony operator via servers connected to this network 102. FIG. 1 shows such a server 104.

Terminal 101 includes a communications interface that allows it to establish a connection 103 with network 102. This communications interface consists of a radio antenna 105 and radio interface circuits 106 assuring transcoding between the analog signals on the side of antenna 105 and the digital signals in terminal 101. Conventionally, terminal 101 includes a microprocessor 107, a program memory 108, and input/output means 109. Input/output means 109 include a keyboard and a screen.

Terminal 101 further includes a data memory 110. It is in this memory that the active data received by terminal 101 is recorded. A memory 111 of terminal 101 allows the configuration of that terminal to be recorded, and particularly enables the prescribed response of terminal 101 to be recorded, depending on the type of active data received.

Memory 108 includes several zones. In particular, memory 108 includes a zone 108a that carries instruction codes for controlling microprocessor 107 when terminal 101 communicates with server 104, that is to say when telephone 101 communicates with the operator. A zone 108b includes instruction codes corresponding to the interpretation, or execution, of the active data received by terminal 101. Terminal 101 includes a zone 108c corresponding to an update of the subscriber's configuration on server 104.

For terminal 101, as for the other devices that will be described in the following, a certain number of memories are described. For a given device, this group of memories, may well consist of just a few zones of the same memory. The exploded illustration of the elements is provided as an aid to understanding.

Elements 106 to 111 are connected by a bus 112. Network 102, and thus also terminal 101, function according to any existing or future mobile telephony standards. These standards include for example GSM, PCS, DCS, GPRS and UMTS.

The operator's server 104 includes circuits 113, which enable it to establish an interface between network 102 and server 104. Server 104 includes a microprocessor 114 and a program memory 115. Memory 115 is divided into a number of zones containing instruction codes that control microprocessor 114 depending on circumstances. One zone 115a enables server 104 to communicate with terminal 101, one zone 115b enables server 104 to communicate with a provider wishing to use the operator's network 102. One zone 115c enables server 104 to perform filtering operations on messages received by server 104. One zone 115d enables server 104 to update an operator's subscriber memory 116.

Server 104 also includes a provider memory 117. Terminal 104 also includes interface circuits 118 between server 104 and a telecommunications network 119, for example the Internet. Elements 113 to 118 are connected to a bus 120.

Tables 116 and 117 are table-structured memories. Each line corresponds to an item of information, each column corresponds to a record. Table 116 permits the recording of information on an operator's subscribers, and table 117 permits recording of information on providers wishing to use the network of the operator managing server 104.

Table 117 includes a line 117a corresponding to a provider identifier, and lines 117.1 to 117.n correspond to the provider's authorizations depending on the data types that the provider is authorised to send across the operator's network. Thus each line corresponds to a type.

Table 116 includes a line 116a to record a subscriber identifier. In the case of a mobile telephone network, line identifier 116a is, for example, a telephone number or a SIM card number. Table 116 also includes lines 116.1 to 116n corresponding to the descriptions of the data types the subscriber wishes to receive or otherwise. Each line 116.1 to 116n thus corresponds to a data type, and each line therefore provides information regarding whether the subscriber wishes to receive this data type or not. Table 116 also includes a line 116b where the providers' identifiers can be recorded. This line in fact corresponds to a subscriber's black list. All providers whose identifiers are recorded in this line for a given subscriber are providers from whom the subscriber does not wish to receive any type of data. Line 116c permits recording the subscriber's credit. Indeed it is possible that the receipt of certain data may be subject to the payment of a fee, in this case it is necessary to be able to assure that the subscriber does indeed possess such rights.

FIG. 1 also shows a server 121 corresponding to a device of a provider wishing to use network 102 of the operator managing server 104. For the purposes of the description, the example is given of a provider or server 121 wishing to transfer active data recorded in a memory 122 to terminal 101. Server 121 includes a microprocessor 123, a program memory 124, and interface circuits 125 for communicating with network 119. Elements 122 to 125 are connected by a bus 126. Memory 124 includes a zone 124a enabling the implementation of communication functions with the operator's server 104.

All the elements described for FIG. 1 are engaged by the process according to the invention. The steps of this process are illustrated in FIG. 2.

FIG. 2 shows a preliminary transmission step 201 of a request by the provider to transmit active data. In step 201, the provider, that is to say in fact server 121, composes a frame of the kind shown in FIG. 3. This frame, or request, includes a field 301 identifying the provider, a field 302 identifying a one of the operator's subscribers, a field 303 identifying the data type that the provider wishes to transmit, and a field 304 corresponding to a code identifying the nature of the request. In this case, it concerns a request for transmission of active data. Once composed, this request is transmitted to the operator by the provider. This transmission is handled by activation of a communications protocol implemented by instruction codes from zones 124a and 115b. This request thus passes across network 119, is received by circuits 118, and is finally handled by microprocessor 114. This processing corresponds to a processing step 202 of the request defined by the provider and the subscriber.

Step 202 may be divided into several sub-steps. A first sub-step 203 corresponds to verification or approval of the provider's authorisation. In sub-step 203, the operator verifies that identifier 301 is present in the first line of table 117. If it is present, the operator checks the column in table 117 that is referenced by identifier 301 to determine whether the said provider is authorised to transmit the type of data identified in field 303 on network 102. This is done by searching in the column corresponding to the provider for the line corresponding to the type identified by field 303. This line thus provides information on the provider's authorisation for the data type identified by field 303. If the provider is present in table 117, and if it is authorised to transmit the type of data identified by field 303, the procedure moves to sub-step 204; otherwise it passes to sub-step 205 for transmission of a refusal.

In sub-step 204, or a second sub-step for subscriber identification, the operator checks whether the provider's request is compatible with the subscriber's configuration. To do so, the operator searches table 116 for the identifier recorded in field 302. Once the subscriber is found in table 116, the operator also searches lines 116.1 to 116n to determine whether the subscriber is permitted to receive the data type identified in field 303. In sub-step 204, the operator also checks whether the identifier recorded in field 301 is not in the list of line 116b, corresponding to the subscriber identified by field 302. If the subscriber identified by field 302 is present in table 116a, if this subscriber authorises receipt of the data type recorded in the field 303, and if the provider identified by field 301 is not on the subscriber's black list 116b, the process advances to a sub-step 206 for transmitting the authorisation.

It should be noted that the order of sub-steps 203 and 204 may be reversed. Sub-steps 203 and 204 constitute a filtering of messages addressed to the subscriber and received by the operator. This filtering is effected on the basis of both the sender and the intended recipient of the message, and of the nature of the message content. From the subscriber's point of view, this filtering constitutes security in terms of the message he effectively receives, in the sense that undesirable messages never reach him.

In sub-step 206, the operator transmits to the provider an authorisation frame signifying that the provider is authorised to transmit the active data with the parameters specified in the request previously issued in step 201.

In sub-step 205, the operator transmits to the provider a frame signifying that it is not authorised to transmit its active data to the subscriber.

From step 202, the process advances to a processing step 207, by the provider, of the response to its request. If authorisation is received it passes to a data transmission step 208, otherwise it passes to an end stage 209.

In step 208 the provider then transmits the active data addressed to the subscriber 101. This data is transmitted according to the protocol implemented by zones 124a and 115b. In step 208, the data is encapsulated in communication protocol frames that the operator and the provider use to communicate. These frames may include an authorisation identifier. Such an identifier is issued, for example, by the provider at the same time as the authorisation frame in sub-step 206. An authorisation identifier of such kind enables the operator to control data transmitted by providers, since it then becomes impossible to transmit any active data without prior authorisation, which means that the data must be accompanied by an authorisation identifier, and this identifier must match the data.

In a step 209, the operator receives active data. Where an authorisation has already been granted for the transmission of this data, the process may advance directly to a step 210 for transmitting this data to the subscriber, but in step 209 the operator may also verify that the active data received actually correspond to that for which the authorisation has been granted, via an authorisation identifier for example.

In step 210, the operator formats the data received from the provider to transmit it to the subscriber. This formatting is useful because the protocols used for communication between the provider and the operator are not necessarily the same as those used for communication between the operator and the subscriber. For example, the data may be transmitted between the operator and the subscriber on the second network managed by the operator, via one or more short messages. A short message of such kind is illustrated in FIG. 4. The short message includes a standard header 401, followed by a field 402 indicating that it refers to active data, then a field 403 including the data. Communications between the provider and the operator may be assured according to an Internet standard protocol (TCP, FTP, . . . ) or any other protocol on which the operator and the provider have agreed. These operator/provider communications are assured on a first network which may be any telecommunications network, for example the Internet or another network, even a private one.

From step 210, the process passes to a step 211 in which the data is received by the subscriber. It may be noted that according to the invention there is no negotiation to determine whether the subscriber wishes to receive the active data transmitted by the provider. In fact these negotiations already took place when the subscriber configured his telephone. The data is transmitted between the operator and the subscriber using the protocol implemented in zones 108a and 115a. When he receives active data on his terminal, it is recorded in memory 110. The processes then passes to an execution step 212 of the active data.

In step 212, microprocessor 107 scans memory 110, controlled by the instruction codes from zone 108b. If memory 110 contains active data in the form of programs that are written in a language which can be interpreted by the instruction codes from zone 108b, these programs are executed. In effect the harmlessness of the content of memory 110 is guaranteed by the operator. From step 212, the process advances to an end step 213.

In a variant of the invention, there are no protocol exchanges between the operator and the provider. The provider merely transmits a message containing active data to a subscriber. The operator verifies that the provider is known and approved, and that the subscriber wishes to receive this active data type from this provider. In this case the operator transmits the active data directly to the subscriber without sending transmission authorisation to the provider.

In a further variant of the invention, the operator receives a message from a provider, which message includes the active data and a certificate that allows the provider to be identified and approved. The operator is then responsible for confirming the validity of the certificate and, if this certificate is valid and the subscriber has not placed the provider on his black list, the operator transmits the active data to the subscriber.

It may be seen that the intention of the invention is actually to shift the responsibility for assuring security of the active data content to an operator to relieve the workload on the devices of the operator's subscribers.

In order determine whether a message includes active data, it is envisaged that this message include a field describing the nature of data that is included in the message. There are other methods for determining the nature of this data. In general an active content is a file with a name and a header. The file name, and particularly the file extension, provides information on the nature of the file, that is to say on the nature of the file content. In the same way the file header also supplies this information on the file's nature. The name and header thus enable a file to be associated with an application. If this application allows interpretation of active data, it is because the file carries the active data. Thus there are many ways to determine the nature of data received via a message.

The invention presents many advantages because the transmission of active data is becoming more and more widespread. Indeed, the interactivity of the data that is accessible on networks via a simple mobile telephone end device is on the increase. The availability of this interactivity is partly due to active data. The active data is of the kind described in the introduction to this patent application, and transmitted according to modes that are also described in the introduction. The provision of security for active data by the operator therefore not only enhances the subscriber's confidence in this data, but also reduces the power consumption of the terminals.

The invention may also be implemented as part of an application executed by a terminal but needing to resort to functions implemented in a library that are not present on the terminal. This library must then be downloaded to the terminal from a server on a network. This library is in fact supplied by a provider. The library is itself active content. Downloading the library, also called DLL, is then subject to a check by the operator. This control check is of the same type as the one presented for the invention.

FIG. 2 also shows steps 214 and 215 for updating the configuration. Step 214 corresponds to an update on the operator side, step 215 corresponds to a update on the subscriber's side. Several methods for backing up the terminal configuration are conceivable.

In a preferred method, the terminal configuration is recorded in table 116. In this case when the subscriber wishes to modify his configuration, he transmits a request, from his terminal to the operator to migrate the content of table 116 relating to him to memory 111. This memory 111 is then edited using input/output means 109. When editing is complete, the subscriber transfers the content edited in memory 111 to memory 116. This preferred methodology means that the operator is aware of the configuration of terminal 101 at all times.

A further embodiment consists in backing up the configuration in memory 111. In this case, each time the operator needs to know the configuration of terminal 101, the operator must query the terminal. Periodic querying of terminal 101 by the operator is also conceivable. With a reasonable period it is thus possible to maintain good consistency between the content of memory 111 and the content of table 116. However this solution tends to increase communications slightly between the operator and the terminal.

In a variant of the invention, the security function, and the configuration back-up function are not installed on the same server 104, but on two or more different servers belonging to the operator. In this case these servers communicate together to exchange the information they require.

It is possible, that access to certain active content may be a chargeable service. For example, an electronic newspaper distributed on network 102 is conceivable. In this case, the provider is also the newspaper publisher. The publisher sends a message, including active data, to the subscriber. This message allows the subscriber to download the newspaper upon payment. The active content is then the program for downloading and payment. In this case, if the subscriber has authorised this type of content in his terminal configuration, the operator verifies that the subscriber's credit is actually sufficient to enable the operation before transferring this content. If the credit is sufficient, the operator debits the subscriber and credits the provider, and then it transfers the active content to the subscriber. The subscriber will then be able to download his electronic newspaper, by executing the active content.

It is evident that the process according to the invention is valuable in the context of active data transmissions, whether these transmissions are solicited or unsolicited. Indeed all active data passes through the operator. All active data may therefore be subjected to a security procedure by the operator. The term solicited is understood to mean the active data transmitted following a request issued by the terminal. The term unsolicited is understood to mean active data transmitted on the provider's initiative.

Depending on the terms of the agreement between the provider and the operator it is possible to leave almost complete control of terminal functions in the hands of the provider. Accordingly, examples of possible applications may include active contents whose interpretation would have the following consequences: unsolicited loading and interpretation of an HTML format file, opening of a terminal port allowing it to communicate directly with that terminal, launching of a session with a messaging server, or updating of a terminal database.

1. A method for remotely assuring security when downloading active data in a terminal by an operator, characterised in that the operator who ensures the interface between the terminal and a provider sending the active data and the terminal implements the following steps:
receipt (202) of a message, via a first telecommunications network,
determination (202) of the nature of the received message, to learn whether the nature of the received message is such that this received message includes active data,
identification (203) of the provider sending the active data,
verification (203) of the provider's accreditation, depending on the nature of the message, based on a provider memory on a second network managed by the operator,
identification (204) of the receiving terminal of the active data based on a subscriber memory,
verification (204) of the receiving terminal's configuration,
if the configuration is compatible with the active data, and if the provider is approved, the operator relays (209 - 210) the active data to the terminal.

2. The method according to claim 1, characterised in that the active data is transmitted (201) on the provider's initiative.

3. The method according to one of claims 1 or 2, characterised in that the active data is transmitted (201) following a request sent by the terminal.

4. The method according to one of claims 1 to 3, characterised in that the operator relays (210) the active data to the terminal via at least one short message (401-403).

5. The method according to claim 4, characterised in that the short message includes a field (402) to identify the nature of data contained in the short message.

6. The method according to one of the claims 1 to 5, characterised in that:
the provider sends (201) a request to the operator for authorisation to transmit unsolicited data, this data being active, the request including an addressee identifier,
the operator receives and processes (202) the request for authorisation to transmit according to the provider's identifier and the recipient's identifier,
the operator (205-206) sends a positive or negative response frame to the provider,
based on the reply frame, the provider (207-208) transmits the active data to the receiving terminal via the operator,
the operator (209-211) transmits the active data to the terminal which records them.

7. The method according to one of claims 1 to 6, characterised in that the terminal interprets (212) the active data to perform the function transmitted by that data.

8. The method according to one of claims 1 to 7, characterised in that a subscriber remotely updates (215), the operator's subscriber memory.

9. The method according to one of claims 1 to 8, characterised in that the operator automatically interrogates (214) the terminal to obtain its configuration and update its subscriber memory.

10. The method according to one of claims 1 to 9, characterised in that the terminal configuration includes a list (116b), recorded in a memory, to designate those providers from whom the terminal user does not wish to receive data.
